(19) United States
(12) Patent Application Publication
(10) Pub. No.: US 2005/0087378 A1
(43) Pub. Date: Apr. 28, 2005

(54) Controlling wheel slip in an agricultural vehicle

(76) Inventor: Oliver Hrazdera, Neuhofen an der Krems (AT)

Correspondence Address: CNH AMERICA LLC, INTELLECTUAL PROPERTY LAW DEPARTMENT, PO BOX 1895, M.S. 641, NEW HOLLAND, PA, 17557, US

(21) Appl. No.: 10/694,330

(22) Filed: Oct. 27, 2003

(51) Int. Cl. B60K 31/00

(52) U.S. Cl. 180/170

(57) ABSTRACT

An agricultural vehicle includes a plurality of wheels, including at least one driving wheel connected to an engine via a gearbox with variable gear ratios, a plurality of tires, and a plurality of wheel-slip-reducing mechanisms, such as a mechanism for moving weight about the vehicle, a mechanism for adjusting drivetrain gear ratios, a mechanism for adjusting tire pressure, and a mechanism for changing engine speed. The vehicle further comprises a central microcomputer to which the mechanisms are electrically connected and a controller for wheel slip adjustment and a controller for setting a minimum vehicle travelling speed, the controllers being connected via the microcomputer with the mechanisms.

### FIELD OF THE INVENTION

This invention relates generally to controlling wheel slip in an agricultural vehicle, and more particularly to a controller for adjusting various controls to control wheel slip on a tractor.

### BACKGROUND OF THE INVENTION

Current agricultural vehicles such as tractors usually have devices for determining the actual speed the vehicle is travelling over land. The vehicle also includes means for determining the rotational speed of each individual wheel and all driving wheels. Current tractors also include mechanisms for controllable variation of the gearbox speed, the engine speed and the travelling speed. These vehicles also include means for varying the tire pressure and devices for determining the coupled load and the positional variation of the coupled load. The device determines and displays wheel slip and includes devices for the recognition and display of the current inclination of the vehicle. In addition, a process controls wheel slip. The device and process are particularly for use on the types of ground encountered in agriculture or forestry.

With the use of agricultural vehicles on agricultural or forestry terrain, especially under wet weather conditions, slip of the driving wheels of up to 25% can occur. That means that up to ¼ of the fuel alone is used up in unproductive wheel slip. Thus with minimization of wheel slip a potential for saving arises through reduced fuel consumption.

Some known tractors employ radar to determine the actual speed over the ground. In doing so the difference between the value for the rotational speed of the wheels and the actual speed over the ground is determined and displayed in a suitable form. If a certain value for wheel slip is exceeded, the only measure for reducing wheel slip is raising the lifting gear. In doing so the implement is lifted and the coupled load is reduced, which has the consequence that wheel slip is reduced accordingly. Furthermore, all-wheel and differential lock management systems are sometimes employed, the only point of which is to reduce wheel slip in the field. A problem with both of these systems is that there is an existing limiting speed at which the management system is automatically deactivated, so that on lowering the lifting gear or lowering the speed the management system is not activated unintentionally. All of the previously existing management systems detect not the wheel slip, but for example lifting gear positions, brake operation, steering brake operation and speeds or possibly even steering movements.

Such devices for controlling wheel slip are known also from various other implementations.

In DE 36 04 218 C2 an electro-hydraulic device for controlling a lifting device on an agricultural working vehicle is described, where the position of the lifting gear is altered by means of a control circuit. The control circuit includes a position sensor, a force sensor and a set value transmitter, the signals from which control the hydraulic motor actuating the lifting gear through an electrical device and a hydraulic valve. From the position and force signals and the signals from an additional sensor, a first summing point is formed, into which the value for the wheel slip signals also enters. From these an output signal is formed, which is input to a mixing device, in which the mixing device is fed through a further input with the set value signal of the position sensor and from this an output signal is formed which is fed to a second summing point, to which simultaneously the set value signal is applied, in order to finally form the control error. In this manner the control of the lifting gear is derived.

However, this function (raising the lifting gear), which is employed also in other technical solutions, is rather counter-productive, as the user will indeed want to plough at a particular depth or cut at a particular height.

A technical solution that seeks to avoid this problem is described in DE 196 49 273 C2, which discloses an agricultural vehicle with a position-controlled lifting gear. A gearbox switches off the load and the gear transmission ratio of the gearbox is variable in steps, by means of a control joined to the gearbox, according to the wheel slip or resistance to traction.

As disclosed in DE 196 49 273 C2, the driving engine possesses a constant power range. The speed of the driving engine is varied by the engine control connected with the gearbox control in accordance with the set gear transmission ratio. The gearbox control may be connected with a read-only memory, in which certain favorable pairs of operating points for the gearbox and the engine are stored. According to DE 196 49 273 C2, control of the gearbox is preferably effected electronically. The associated method describes a position-control for lifting gear in agricultural vehicles, in which the working height or depth is recorded continuously by means of a position sensor, the measured value is compared with a set value and on the basis of the difference a setting parameter is generated, which is tracked against the difference in a lifting gear drive. In addition, a measurement of wheel slip or resistance to traction is made and a gear ratio is selected according to the wheel slip or resistance to traction, or a gear ratio of an at least partially switchable gearbox and an engine speed are selected. DE 196 49 273 C2 indicates that an evenly built up seedbed is produced from an agricultural technical point of view and soil compaction is reliably avoided. However, the disadvantage is that only step-wise control is possible.

It is known, for improving the working speed of modern tractors with position control, to equip the tractors additionally with a wheel slip control, which as a rule are employed in combination with each other. At the same time the maximum permissible wheel slip can be preset. Small variations in the resistance to traction are offset through more or less wheel slip, without them leading to fluctuations in the working depth. Only with large changes in resistance to traction or the adhesion conditions for the driving wheels and hence exceeding of the set limiting value for wheel slip is the position control active and the lifting gear is raised until wheel slip falls again below the preset limiting value. The disadvantage, that under differing soil structures unwanted variations in working depth can come about, still remains.

### SUMMARY OF THE INVENTION

A task of the invention is to reduce energy consumption, especially in operations on agricultural or forestry terrain, and to improve overall ground adhesion for all the different operating conditions, to simplify operation and to increase driver comfort.

According to an aspect of the invention, an agricultural vehicle is equipped with devices for determining the actual travelling speed over land, e.g. with a radar device and/or a GPS device, with which the actual speed over ground is determined. In addition, devices are arranged for determining the rotational speed of each individual and/or all the driving wheels. Determination of the wheel slip-determined speed takes place with the existence of a drive that drives the driven wheels in the same way, via at least one sensor. If a drive mechanism is present, which enables the speed of the various different wheels to be set differently, then accordingly more sensors are arranged, with which the rotational speed of all the wheels and of each individual wheel can be determined. Furthermore, devices for controllable variation of the gear ratio and/or of the individual wheel speeds, the engine speed and hence the driving speed are arranged. The agricultural vehicle possesses a device, with which the air pressure in the tires can be monitored, through which the area of tire applied to the ground for the wheels arranged on the vehicle can be regulated according to the amount of wheel slip detected. Likewise a device for determining the coupled load is arranged. Via special devices a change in position of the coupled load can take place or the coupled load can be reduced. Moreover the vehicle recognizes the load present either through load detectors, or the load is determined from slowing of the engine by comparing the set speed of the engine with the actual engine speed.

A further device serves for determining wheel slip and permits, via the central electronic box, a direct display of wheel slip on a unit within the driver's field of view. In all the actual speed of the vehicle, the wheel speed and the difference between these, namely the wheel slip, is displayed. Likewise there is a device for recognition and display of the current inclination of the vehicle.

In the agricultural vehicle a central microcomputer-controlled electronic box is arranged, in which the input parameters of all devices and also the control signals arising are switched, and a controller for wheel slip adjustment via a priority switch is connected and arranged. A further controller for setting the minimum permissible vehicle speed is connected and arranged via the central electronic box that, according to the controller setting, the gear ratio of a CVT gearbox and the engine speed are regulated simultaneously. In this way an infinitely variable control of the gearbox and also the engine speed is possible. Likewise, by means of a selective setting, the rotational speed of each wheel can be controlled individually.

According to another aspect of the invention, a driving mode switch controls the travelling speed (any desired combination of engine speed and gear ratio is selectable) primarily in accordance with wheel slip. Through the connection and arrangement of the devices in accordance with the invention all input signals and control signals for the devices are switched to a central microcomputer-controlled electronic box and are evaluated in this. As a result of the evaluation, all parameters relevant for wheel slip are indicated to the driver via displays. With actuators it is possible to preset the limiting values, such as maximum wheel slip, minimum driving speed and engine speed.

The driving mode switch in accordance with the invention permits selection of several driving modes according to the preset limiting values in relation to the preset wheel slip. At the same time the relevant devices for controlling the individual vehicle components are adjusted automatically in accordance with a minimized preset wheel slip. Activation of the wheel slip management system occurs by means of an additional push-button, the function of which must be activated afresh after each switching on/off of the ignition. At the same time the function of the push-button is displayed via suitable measures.

If the agricultural vehicle is moving in a field and because of the quality of the ground wheel slip occurs, which lies above the preset value, the all-wheel and differential locks are activated automatically.

If then the steering or also the steering brake are operated, as e.g. during the turning process at the end of the field, the differential lock and possibly also the all-wheel lock are deactivated. After the end of operation of the steering these are automatically switched on again in the presence of wheel slip.

When the field is left, wheel slip is reduced in accordance with the quality of the road surface and both all-wheel and differential locks are switched off automatically. On slippery surfaces (e.g. heavily contaminated roads, snow or black ice) or also during all braking events the all-wheel and differential locks switch on automatically. Naturally the differential lock is switched on only if no steering control or steering brake has been operated.

An advantage of the invention is the omission of all the all-wheel and differential lock management systems of conventional construction. The all-wheel and differential locks are always activated automatically, as soon as the vehicle comes into critical ground adhesion conditions. For the driver, the switching functions in the driver's cab are reduced. Operation of the agricultural vehicle becomes overall simpler and clearer. A significant reduction in wheel slip results, through which a considerable saving in fuel occurs. Through the novel driving mode switch, which can be designed e.g. as a potentiometer, in conjunction with a continuously variable gearbox (CVT gearbox), first the maximum permissible wheel slip is set and then via further devices the permissible driving speed range is set. Setting of the desired driving speed can occur by means of a Tempomat, which is an automatic speed control, or Drivepedal.

The point of this driving mode is to vary the driving speed to the extent that a wheel slip preset, which is set, e.g., by means of a potentiometer, is not exceeded. Now if the wheel slip at the prescribed driving speed rises above the preset value, then the gear ratio and/or the engine speed of the drive are reduced smoothly (and with it also the driving speed) until wheel slip has fallen below the set value again. Then the gear ratio rises again. The control automatically adjusts the speed to the desired value for wheel slip, even if the set value for speed is above this value. In addition, a minimum permissible speed can be set. Dropping below this value is not possible, as on attaining the minimum speed the priority of wheel slip control is put out of action or further measures for reduction of wheel slip can be initiated. The change in engine speed is likewise a control parameter and influences wheel slip control, as in the event of very high wheel slip almost no load is measured from the vehicle (almost no advance occurs or at the engine only quite slight or no pressure is detected or no or only a small signal level runs from the traction power sensors) and thereby a great fall in engine speed comes about in vehicles equipped with engine-gearbox management systems. A change in wheel speed can be applied through all the axles, to pairs of axles or to each wheel individually. Through the controller the speed varies between the desired set value and the minimum set value in accordance with the preset value for wheel slip without intervention by the driver, through which the comfort for operation is further increased.

For reduction of wheel slip according to the invention, further devices (actuators) are envisaged in or on the agricultural vehicle, such as devices or actuators for displacing the center of gravity of the vehicle. In doing so the driver can select whether first the speed of the vehicle or appropriate additional devices, so-called further actuators, are brought into play. Thus among other things, by suitable measures the position of the front axles can be altered or a weight outside the vehicle's center of gravity can be displaced or the contents of the tanks can be pumped around. These activities are likewise presettable and are then subject to the automatic control system. After being preset they do not require any operation or attention on the part of the driver.

In a further embodiment at least one interface is connected and arranged on the vehicle, which monitors the power uptake of the attached implements and through which a change, particularly a reduction in power uptake of the attached implement can take place.

The change in the center of gravity of the vehicle can be effected with mechanically, hydraulically, pneumatically or electrically adjustable and or displaceable weights depending upon the wheel slip at the driving wheels, in which these changes are controllable by means of the wheel slip management system or via the central electronic box.

In another embodiment the center of gravity of the vehicle can be altered while travelling by pumping fuel to fuel tanks, which are arranged at different places on the vehicle and connected with each other, using one or more controlled pumps. This change is likewise subject to dependence upon the wheel slip at the driving wheels and is controllable via the wheel slip management system. In another solution for a fuel tank arranged on the vehicle the tank is divided into several compartments. These compartments can be filled with fuel independently of each other by means of one or more pumps while travelling, by which center of gravity of the vehicle can be influenced in accordance with the wheel slip at the driving wheels.

In a further embodiment of the invention the area of tire in contact with the ground for the wheels arranged on the vehicle can be varied by altering the air pressure in the tires in accordance with the preset maximum wheel slip. Thus for example by reducing the air pressure in the tire the tire area in contact with the ground can be increased, which diminishes wheel slip.

Furthermore, the speed of the front wheels of the vehicle can be changed relative to the speed of the rear wheels, if these can be driven independently of the rear wheels.

In a further embodiment of the invention, the wheels of the agricultural vehicle can, through special constructional measures on the vehicle, be set at an angle to the longitudinal axis and/or the vertical axis of the vehicle while travelling. In this way a reduction in wheel slip occurs. All these additional measures, when they are arranged on or in the agricultural vehicle and are employed, can be controlled via the central electronic box of the wheel slip management system. Thus power transmission via the driving wheels can be improved and wheel slip minimized.

It is advantageous, if one or all the wheels can be driven and controlled at different speeds in accordance with the wheel slip. This solution offers an advantage, particularly under difficult ground conditions or for use on hillside locations, for optimal energy saving and comfortable driving of the agricultural vehicle.

### BRIEF DESCRIPTION OF THE DRAWINGS

The invention will be described in more detail in the following using a drawing.

FIG. 1 shows a schematic side view of an agricultural vehicle in an embodiment as a tractor with components in accordance with the invention and their arrangement and their connection with each other.

### DETAILED DESCRIPTION OF THE PREFERRED EMBODIMENT

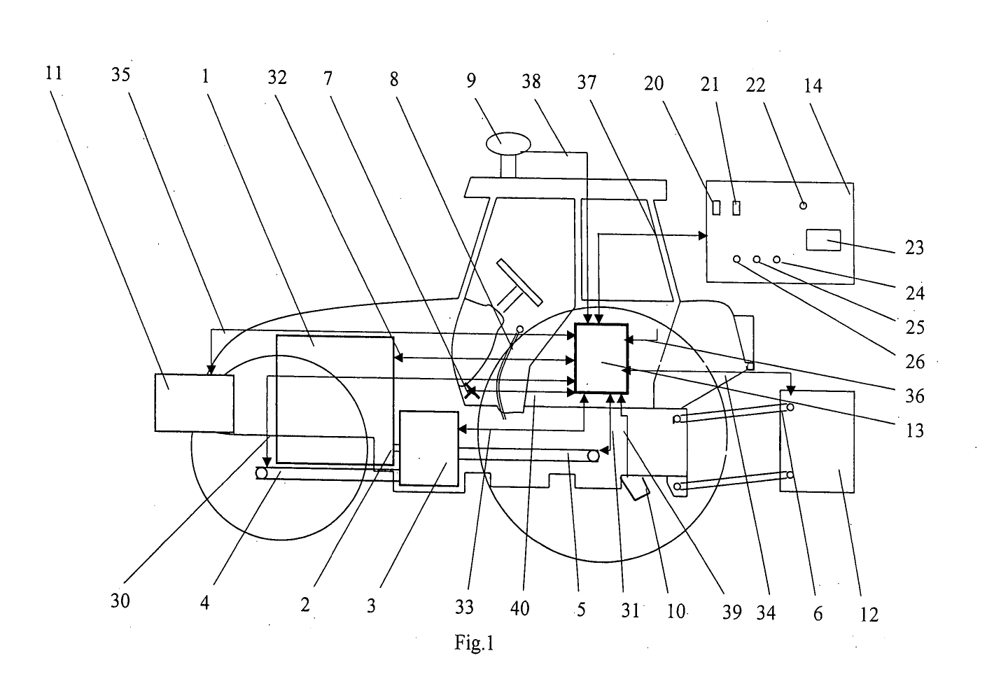

The tractor has a central drive such as the engine (1). The engine drives an engine shaft (2), which drives a CVT gearbox (3), such as a continuously variable ratio gearbox. The CVT gearbox (3) is coupled to the front wheels via a drive shaft (4). The drive shaft (5) couples the rear wheels with the CVT gearbox (3). At least one wheel speed sensor is arranged on each individual wheel, which is connected with a central electronic box (13). The box (13) is connected via the connecting lead (30) for monitoring and regulating the rotational speed of the front wheels and via connecting lead (31) for monitoring and regulating the rotational speed of the rear wheels. (In FIG. 1 the wheel speed sensors are not depicted.) In an embodiment, both on the rear wheels and also on the front wheels, each wheel device (actuators not depicted in FIG. 1) is arranged for regulating the rotational speed of each individual wheel, so that each individual wheel can be variably controlled independently of the others within a certain range.

On the tractor a lifting gear (6) holds a connectable load (12), such as an agricultural implement or carriage. The accelerator pedal (7) is connected with the central electronic box (13) via signal lead (40). Likewise the engine (1) is connected via the engine control bus (32), the CVT gearbox (3) is connected via the gearbox control bus (33) and the tire air pressure monitoring unit with the individual wheels is connected, via connecting lead (36) for controlling and monitoring the tire air pressure, to the central electronic box (13). In addition, the lifting gear (6) with load sensor and lift position sensor is connected with the central electronic box (13) via a connecting lead (34) for controlling and monitoring the power uptake and the position of the lift and thus the load. In an embodiment of the invention the power uptake of the implement built onto it can be varied during operation, thus in the case of a plough, for example, through a reduction of the ploughed width the coupled load, i.e. the power uptake, can be reduced.

On the tractor a GPS antenna (9) is arranged and under the vehicle a radar device (10) is arranged, the signals from which are fed into the central electronic box via signal leads (38) and (39) and evaluated. Through this it is possible, at any desired time, to determine and display the precise speed over the ground. Furthermore, the signals from the steering, the position of the gear lever (8) and operation of the brakes are monitored and evaluated in the central electronic box (the connecting leads are not depicted in FIG. 1). In addition, on the tractor, a device in accordance with the invention is arranged for changing the center of gravity of the vehicle. In this example adjustable and movable weights (11) are arranged on the tractor in the frontal zone, so that their position can be varied, with the aid of which the vehicle's center of gravity can be altered, depending upon the wheel slip, while travelling. The moveable and adjustable weights (11) are connected with the central electronic box (13) via the connecting lead (35) for controlling and monitoring the vehicle's center of gravity and also obtaining control signals from this for varying their position.

The central electronic box (13) evaluates with computer control all the relevant incoming signals in accordance with time and priority and delivers the necessary data to a suitable control and display unit (14) located within the driver's field of view in the driver's cab. For this the control and display unit (14) are connected with the central electronic box (13) via an information bus (37) for displaying the requisite parameters and feedback of the adjustable control data. The driver inputs control signals via the control and display unit (14), which are in turn evaluated in the central electronic box (13) and as a result control commands for the individual devices (actuators) are delivered, which are arranged in various different places on the tractor and which determine and permit an optimal, energy-saving travel of the tractor.

On the control and display unit (14) there are a mode switch for wheel slip (20) for selecting the desired type of wheel slip control; a device for setting the type of control (21), which permits the setting of priorities for the selection and sequence of wheel slip reducing measures and actuation of the corresponding devices (actuators); a signal lamp for wheel slip (22), for displaying the engagement of wheel slip control; a display device for wheel slip (23), for indicating the actual wheel slip; an adjustment control for set speed (24); a setting control for minimum speed (25), for the selection and setting of the minimum permissible speed of the tractor over the ground and a setting control for wheel slip (26), for selecting and setting a maximum permissible wheel slip.

Through the wheel slip control in accordance with the invention, in the operation of the tractor all data and signals relevant for operation and driving are collected in the central microcomputer-controlled electronic box (13), and assessed and evaluated. In it a ROM is arranged, which contains the fixed preset limiting values and data for the driving mode. For the essential wheel slip relevant parameters the display occurs via the control and display unit (14) by means of suitable display devices. With this information the driver can select several driving modes by means of the mode switch for wheel slip (20) depending upon the adjustable limiting values for permissible wheel slip, minimum speed and set speed. Furthermore, he can select appropriate devices (actuators) for controlling the individual vehicle components in order of priority depending upon a minimized settable wheel slip, set and then control them automatically by means of the central electronic box (13).

Thus setting of engine speed and gear ratio takes place in accordance with the measured actual current load. If the load falls, in order to save fuel the engine speed falls while maintaining a constant travelling speed.

If, during travelling, wheel slip gets into a range that exceeds the maximum permissible wheel slip, the all-wheel and differential locks are switched on automatically. Furthermore, the combined engine and gearbox control system attempts to find a setting at which lower wheel slip values occur. If reduction of wheel slip is possible only by reducing the wheel speed, then this is lowered down to the preset minimum permissible travelling speed.

Through this it is possible in an agricultural vehicle, in this case a tractor, at every operating point (wheel slip and detected load) within the control ranges of engine speed and gear ratio, to approximate to the economically viewed best point for fuel consumption and to reduce consumption consistent with optimal working performance.

If during travel the setting of the display unit for wheel slip (23), i.e. the maximum permissible wheel slip, is exceeded and the actual speed over the ground falls below the value for the preset minimum permissible speed, then via the gearbox-engine control system reductions in the load on the attached implement are undertaken (e.g., via ISOBUS). If the vehicle is equipped with appropriate further advantageous devices (actuators) in accordance with the invention, in addition, the center of gravity of the entire arrangement of vehicle and attached implement is displaced in such a way that additional weight is applied to the driving wheels and thus wheel slip is reduced, and the vehicle comes again into the control range between maximum permissible wheel slip and minimum permissible speed. Furthermore, if the vehicle possesses appropriate devices (actuators), the angle of inclination of the wheels can be adjusted accordingly. This too serves to reduce wheel slip and hence also reduces fuel consumption. Moreover, through an overall quieter running of the engine the vehicle noise both inside the tractor and also for the environment is diminished.

The solution in accordance with the invention is also applicable for agricultural vehicles which are driven with electrical wheel hub motors.

1. An agricultural vehicle includes:
a plurality of wheels, including at least one driving wheel connected to an engine via a gearbox with variable gear ratios;
a plurality of tires;
means for determining the actual travelling speed over the land;
means for determining the speed of rotation of each wheel;
means for controllable variation of the gearbox ratio;
means for varying the air pressure in the tires;
means for changing the position of the center of gravity of the agricultural vehicle;
a central microcomputer to which the means are electrically connected; and
a controller for wheel slip adjustment and a controller for setting a minimum vehicle travelling speed, the controllers being connected via the microcomputer with the means varying the gear ratio of the gearbox,
wherein the microcomputer controls via the controllers at least one of the means for controllable variation of the gearbox ratio, the means for varying the air pressure in the tires, the means for changing the position of the center of gravity, and a speed of the engine based on an input from the means for determining the actual travelling speed over land and the means for determining the speed of rotation of each wheel.

2. The agricultural vehicle of claim 1, wherein control priorities are selectable in accordance with adjustable limiting values.

3. The agricultural vehicle in accordance with claim 1, further comprising means for changing a power uptake of an implement, wherein the microcomputer controls the means for changing a power uptake in accordance with a power uptake monitor.

4. The agricultural vehicle in accordance with claim 1, wherein the means for changing the position of the center of gravity includes mechanical, hydraulic, pneumatic or electrically adjustable weights.

5. The agricultural vehicle in accordance with claim 1, wherein the means for changing the position of the center of gravity includes fuel tanks arranged at various places on the vehicle and connected with each other, and one or more pumps for circulating the fuel.

6. The agricultural vehicle in accordance with claim 1, wherein the means for changing the position of the center of gravity includes a fuel tank arranged on the vehicle that is subdivided, wherein the subdivisions are filled independently of each other with fuel through one or more pumps while travelling.

7. The agricultural vehicle in accordance with claim 1, wherein the means for controllable variation of the gearbox ratio is adapted to vary the rotational speed of the front wheels of the vehicle relative to the rotational speed of the rear wheels.

8. The agricultural vehicle in accordance with claim 1, wherein the wheels of the vehicle are set obliquely to the longitudinal or vertical axis of the agricultural vehicle.

9. The agricultural vehicle in accordance with claim 1, wherein means for controllable variation of the gearbox ratio is adapted to vary one or all of the wheels with differing speeds of rotation.

10. The agricultural vehicle in accordance with claim 2, wherein the microcomputer controls engine speed based on the selected control priorities.
